(19) United States
(12) Patent Application Publication
(10) Pub. No.: US 2012/0066708 A1
(43) Pub. Date: Mar. 15, 2012

(54) SYSTEM METHOD FOR DISPLAYING ADDITIONAL SERVICE INFORMATION OF CONTENT ON AUXILIARY TERMINAL

(75) Inventors: Jooyoung Lee, Daejeon (KR); Jeho Nam, Daejeon (KR); Younhee Kim, Daejeon (KR)

(73) Assignee: ELECTRONICS AND TELECOMMUNICATIONS RESEARCH INSTITUTE, Daejeon (KR)

(21) Appl. No.: 13/227,782

(22) Filed: Sep. 8, 2011

(30) Foreign Application Priority Data
Sep. 10, 2010 (KR) 10-2010-0088724

(51) Int. Cl. H04N 21/2347; H04N 21/431

(52) U.S. Cl. 725/31; 725/40

(57) ABSTRACT

A system and method for displaying additional service information of a content on an auxiliary terminal are provided. The auxiliary terminal may extract a portion of a content output from an external device, may analyze at least one piece of feature from the extracted portion of the content, and may receive additional service information corresponding to the content from a selected server. Additionally, the selected sever for providing the additional service information may associate the feature with the additional service information, and may store the feature and the additional service information.

### CROSS-REFERENCE TO RELATED APPLICATION

This application claims the benefit of Korean Patent Application No. 10-2010-0088724, filed on Sep. 10, 2010, in the Korean Intellectual Property Office, the disclosure of which is incorporated herein by reference.

### BACKGROUND

1. Field

The present invention relates to an auxiliary terminal to extract a portion of an output content, to analyze feature from the extracted portion of the content, and to receive additional service information corresponding to the content from a server based on the analyzed feature, and relates to a system including the auxiliary terminal.

2. Description of the Related Art

As a digital content market is revitalized, a digital content usage environment is being changed from a conventional environment for passive playback and viewing of content to an environment where a user actively participates in playback and viewing of content.

Due to the flow of the times, in a digital content usage environment, technologies and services for providing various types of additional information of content in response to user's requests have been developed. However, in most of digital content usage environments, a physical limitation that a viewer uses digital content through a single image playback device has become a serious barrier to activation of a service to provide additional information of content.

In an example, a playback device for outputting digital content may output main content, and simultaneously may display additional service information.

Specifically, in the case of content of an image type, the playback device may display additional service information, such as an Electronic Program Guide (EPG) and the like, so that the additional service information may be superimposed on a currently output broadcast content, namely the main content.

In other words, since a portion of the main content may be covered, a user may feel inconvenience in using content.

In another example, a playback device for outputting digital content needs to perform a series of processes to display additional information, while outputting the digital content, in to order to provide the additional information. Accordingly, the playback device requires components with high specifications.

Specifically, the playback device needs to perform another process to send a request for additional information to a server, to receive the additional information in response to the request, and to output the received additional information through an output device, independently of the outputting of the digital content.

Accordingly, the playback device requires high system specifications. Additionally, when a channel for requesting and receiving the additional information is identical to a channel for receiving the digital content, a great number of channel bands required to transmit or receive data are demanded to be ensured.

### SUMMARY

The foregoing and/or other aspects are achieved by providing an auxiliary terminal including a content extractor to extract a portion of a content from the content, the content being output from an external device, a feature analyzer to analyze at least one piece of feature from the extracted portion of the content, and an additional service information receiver to receive, from a selected server, additional service information corresponding to the content, based on the analyzed feature, the selected server associating the feature with the additional service information and storing the feature and the additional service information.

The foregoing and/or other aspects are also achieved by providing an auxiliary terminal including a content extractor to extract a portion of a content from the content, the content being output from an external device, a content processor to process the extracted portion of the content in a selected format, and an additional service information receiver to transmit the processed portion of the content to a selected server, and to receive, from the selected server, additional service information corresponding to the processed portion of the content, wherein the selected server associates feature with the additional service information, to stores the feature and the additional service information, analyzes the feature from the processed portion of the content, extracts the additional service information corresponding to the analyzed feature, and transmits the extracted additional service information to the additional service information receiver.

The foregoing and/or other aspects are achieved by providing an additional service information providing system including an additional service information providing server to store and maintain at least one piece of feature and additional service information corresponding to the feature, and an auxiliary terminal to analyze feature from a portion of a content output from an external device, and to receive additional service information corresponding to the content from the additional service information providing server based on the analyzed feature.

The foregoing and/or other aspects are also achieved by providing an additional service information providing system including an additional service information providing server to store and maintain at least one piece of feature, and additional service information corresponding to the feature, and an auxiliary terminal to receive additional service information corresponding to a content from the additional service information providing server based on a portion of the content, the content being output from an external device, wherein the additional service information providing server analyzes the feature from the portion of the content, extracts the additional service information corresponding to the analyzed feature, and provides the auxiliary terminal with the extracted additional service information.

The foregoing and/or other aspects are achieved by providing an operating method of an auxiliary terminal, including extracting a portion of a content from the content, the content being output from an external device, analyzing at least one piece of feature from the extracted portion of the content, and receiving, from a selected server, additional service information corresponding to the content, based on the analyzed feature, the selected server to associating the feature with the additional service information and storing the feature and the additional service information.

The foregoing and/or other aspects are achieved by providing a method of providing additional service information, including storing and maintaining, in an additional service information providing server, at least one piece of feature, and additional service information corresponding to the feature, and analyzing feature from a portion of a content output from an external device and receiving additional service information corresponding to the content from the additional service information providing server based on the analyzed feature.

Additional aspects, features, and/or advantages of example embodiments of the present invention will be set forth in part in the description which follows and, in part, will be apparent from the description, or may be learned by practice of the disclosure.

### BRIEF DESCRIPTION OF THE DRAWINGS

These and/or other aspects and advantages will become apparent and more readily appreciated from the following description of the example embodiments of the present invention, taken in conjunction with the accompanying drawings of which:

FIG. 1 illustrates a diagram of a system for providing additional service information according to an example embodiment of the present invention;

FIG. 2 illustrates a block diagram of an auxiliary terminal according to an example embodiment of the present invention;

FIG. 3 illustrates a block diagram of an auxiliary terminal according to another example embodiment of the present invention;

FIG. 4 illustrates a diagram of additional service information displayed by an auxiliary terminal according to an example embodiment of the present invention;

FIG. 5 illustrates a diagram of additional service information displayed by an auxiliary terminal according to another example embodiment of the present invention;

FIG. 6 illustrates a flowchart of a method of providing additional service information according to an example embodiment of the present invention; and

FIG. 7 illustrates a flowchart of a method of providing additional service information according to another example embodiment of the present invention.

### DETAILED DESCRIPTION

Reference will now be made in detail to example embodiments of the present invention, examples of which are illustrated in the accompanying drawings, wherein like reference numerals refer to the like elements throughout. Example embodiments of the present invention are described below to explain the present disclosure by referring to the figures.

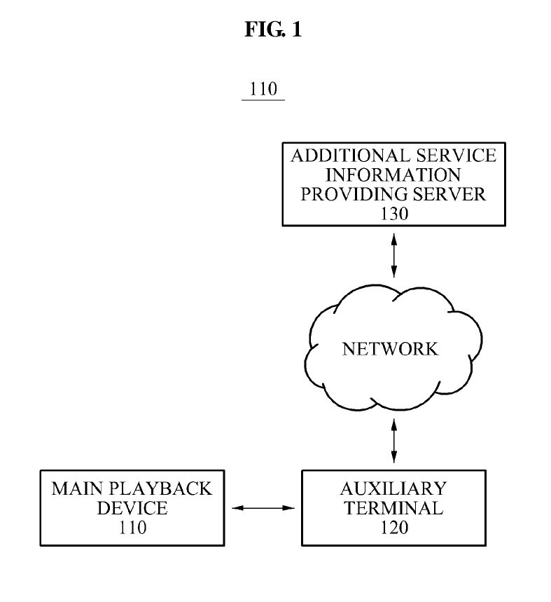

FIG. 1 illustrates a diagram of a system 100 for providing additional service information according to an example embodiment of the present invention.

The system 100 of FIG. 1 may display, through an auxiliary terminal 120, additional service information associated with a content output via a main playback device 110.

The additional service information may include at least one of content description information, advertisement information, and Electronic Program Guide (EPG) information.

Specifically, the main playback device 110 may receive a content of an image type or sound type provided by a content provider, and may output the received content.

To output the received content, the main playback device 110 may be interpreted as a device including a display module or a speaker module.

In an example in which the main playback device 110 outputs an image content, the auxiliary terminal 120 may acquire a capture image by capturing the output image content.

The auxiliary terminal 120 may analyze the capture image, and may extract feature.

In this example, the auxiliary terminal 120 may be a communication device including a camera module for capturing an image content, and may be interpreted as a cellular phone for convenience of understanding.

The auxiliary terminal 120 may transmit the extracted feature to an additional service information providing server 130 via a network.

The additional service information providing server 130 may store and maintain, in a database, at least one piece of feature, and at least one piece of additional service information corresponding to the at least one piece of feature.

When the extracted feature is received, the additional service information providing server 130 may read additional service information corresponding to the received feature from the database.

Subsequently, the additional service information providing server 130 may provide the auxiliary terminal 120 with the read additional service information via the network.

Similarly, in another example in which the main playback device 110 outputs a sound content, the auxiliary terminal 120 may acquire a recoding file by recoding the output sound content.

In this example, the auxiliary terminal 120 may be a communication device including a microphone module for recording a sound content, and may be interpreted as a cellular phone for convenience of understanding.

The auxiliary terminal 120 may analyze the recording file, and may extract feature.

A technology for extracting a characteristic point or feature from an image or a sound is well known to those skilled in the art and accordingly, a further description thereof will be omitted.

The auxiliary terminal 120 may transmit the extracted feature to the additional service information providing server 130, and may receive additional service information corresponding to the feature from the additional service information providing server 130.

The auxiliary terminal 120 may display, on a screen, the additional service information received from the additional service information providing server 130.

According to the example embodiment of the present invention, it is possible to display additional service information regarding viewing content or advertisement through an auxiliary terminal, without limiting a playback and viewing of content.

Additionally, it is possible to minimize costs for realizing an interface between the main playback device 110 and the auxiliary terminal 120 for acquiring additional service information. Also, it is possible to ensure compatibility between the auxiliary terminal 120 and conventional various playback devices, so that the auxiliary terminal 120 may acquire additional service information.

Furthermore, a frequency band used by the main playback device 110 may be used only to receive content and thus, it is possible to prevent a load on system resources.

As an example, the auxiliary terminal 120 may transmit the capture image or the recording file directly to the additional service information providing server 130, rather than analyzing the feature.

In this example, the additional service information providing server 130 may analyze the received capture image or the received recording file, and may extract feature.

When the feature is extracted, the additional service information providing server 130 may read additional service information corresponding to the extracted feature, based on the extracted feature, and may provide the read additional service information to the auxiliary terminal 120.

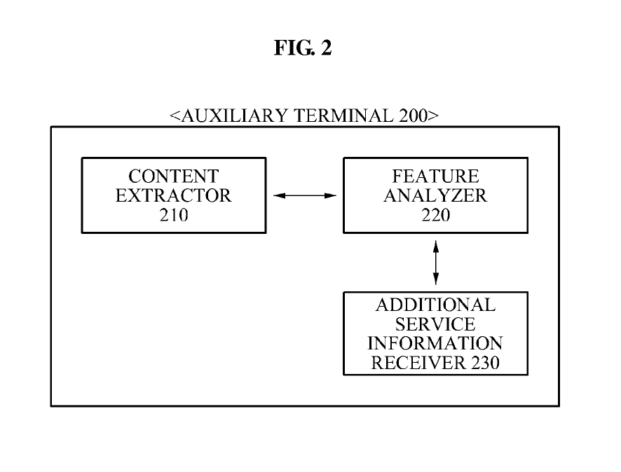

FIG. 2 illustrates a block diagram of an auxiliary terminal 200 according to an example embodiment of the present invention.

The auxiliary terminal 200 of FIG. 2 may extract a portion of a content output from a main playback device, and may acquire, from a selected server, additional service information corresponding to the output content, based on the extracted portion of the content. Here, the selected server may be, for example the additional service information providing server 130 of FIG. 1.

Accordingly, the auxiliary terminal 200 of FIG. 2 may include a content extractor 210, a feature analyzer 220, and an additional service information receiver 230.

The content extractor 210 may extract a portion of a content from the content. Here, the content may be output from an external device (hereinafter, is referred to as a main playback device).

The main playback device may be interpreted as all devices enabling output of image content and sound content, for example a television (TV), a radio, and the like.

The feature analyzer 220 may analyze at least one piece of feature from the extracted portion of the content.

In an example in which an image content is output from the main playback device, the content extractor 210 may acquire a capture image by capturing the output image content, to extract a portion of the image content.

In this example, the feature analyzer 220 may analyze feature from the extracted portion of the image content. Specifically, the feature analyzer 220 may analyze at least one of luminance information and color information that are included in the capture image.

The feature may be interpreted, for example, as a water mark contained in the image content.

In other words, the feature may be information inserted into content during creation or transmission of the content, without interfering with viewing of the content.

In another example in which a sound content is output from the main playback device, the content extractor 210 may acquire a recording file by recording the sound content, to extract a portion of the sound content.

In this example, the feature may be interpreted as frequency information for each period contained in the recording file.

The additional service information receiver 230 may receive, from a selected server, additional service information corresponding to the content, based on the analyzed feature.

Specifically, the additional service information receiver 230 may transmit the analyzed feature to the selected server, and may receive, from the selected server, the additional service information in response to the transmission of the analyzed feature. Here, an additional service information providing server may be selected as a server.

Additionally, the auxiliary terminal 200 may display the received additional service information on a screen through a display means.

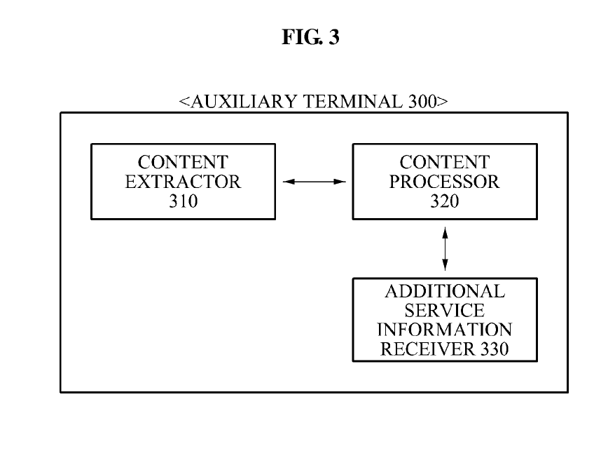

FIG. 3 illustrates a block diagram of an auxiliary terminal 300 according to another example embodiment of the present invention.

The auxiliary terminal 300 of FIG. 3 may only extract a portion of a content output from a main playback device, may transmit the extracted portion of the content to an additional service information providing server, and may acquire additional service information from the additional service information providing server, unlike the auxiliary terminal 200 of FIG. 2.

In other words, the additional service information providing server may analyze feature from the received portion of the content, rather than the auxiliary terminal 300 analyzing the feature.

Accordingly, the auxiliary terminal 300 may include a content extractor 310, a content processor 320, and an additional service information receiver 330.

Specifically, the content extractor 310 may extract a portion of a content from the content. Here, the content may be output from an external device playback device. The content processor 320 may process the extracted portion of the content in a selected format.

For example, the content processor 320 may process the extracted portion of the content by performing at least one of resizing, extracting of a Region Of Interest (ROI), compressing, and encrypting.

Specifically, the content processor 320 may provide a function of processing acquired image data or acquired sound data in a format suitable for being transmitted to a server. For example, resizing, and extracting of ROI may be performed on the image data, and compressing, and encrypting for security may be performed on the image data and sound data. In addition, the content processor 320 may process data in various forms for security and transmission and reception efficiency.

The additional service information receiver 330 may transmit the processed portion of the content to a selected server, and may receive, from the selected server, additional service information corresponding to the processed portion of the content.

The selected server, namely an additional service information providing server, may associate the feature with the additional service information, may store the feature and the additional service information, may analyze the feature from the processed portion of the content, may extract the additional service information corresponding to the analyzed feature, and may transmit the extracted additional service information to the additional service information receiver 330.

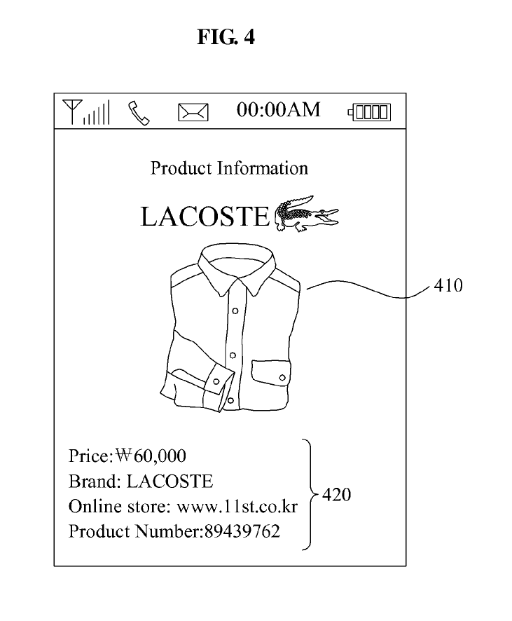

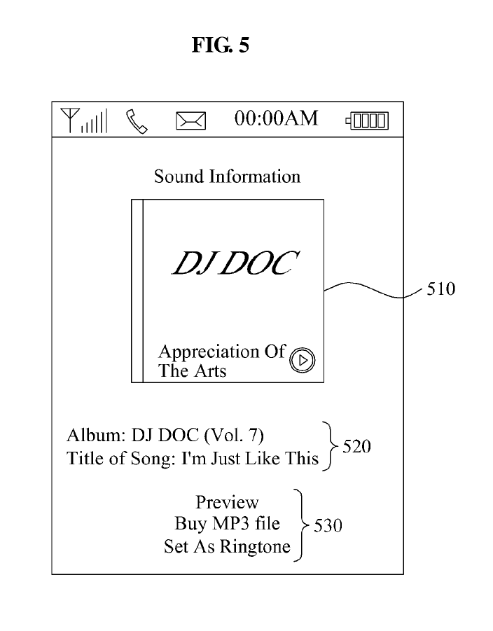

Hereinafter, examples of additional service information will be described in detail with reference to FIGS. 4 and 5.

An auxiliary terminal according to an example embodiment of the present invention may be interpreted as a mobile communication terminal including at least one of a camera module and a microphone module.

FIG. 4 illustrates additional service information displayed by an auxiliary terminal 400 according to an example embodiment of the present invention.

The auxiliary terminal 400 of FIG. 4 may analyze feature of a capture image extracted from an image content, may transmit the analyzed feature to an additional service information providing server, and may receive additional service information.

As illustrated in FIG. 4, additional service information may include product information associated with a T-shirt.

Specifically, the auxiliary terminal 400 may display a T-shirt image 410, and product detailed information 420 that are included in the additional service information.

In other words, an image content may be a content including a T-shirt image, and a user may view detailed information regarding a product of interest by verifying the displayed additional service information.

Additionally, the additional service information may further include an icon indicating a link to a Uniform Resource Locator (URL) classified as an online store.

Accordingly, a user may select the icon, and may view a site where the user may buy the product of interest.

FIG. 5 illustrates additional service information displayed by an auxiliary terminal 500 according to another example embodiment of the present invention.

The auxiliary terminal 500 of FIG. 5 may analyze feature of a recording file extracted from a sound content, may transmit the analyzed feature to an additional service information providing server, and may receive additional service information.

As illustrated in FIG. 5, additional service information may be interpreted as detailed information regarding a predetermined song. Specifically, the additional service information may include an album image 510, and detailed information 520 including a title of an album and a title of a song corresponding to the recording file.

Accordingly, the auxiliary terminal 500 may display detailed information regarding the original song of the recording file.

For example, the sound content may be a song titled as ‘I'm Just Like This’ in the seventh album of DJ DOC, and the recording file may be acquired by recording a predetermined portion of the song.

Additionally, the auxiliary terminal 500 may provide options 530, for example ‘Preview’, ‘Buy MP3 file’, and ‘Set As Ringtone’ with respect to the song titled as ‘I'm Just Like This’.

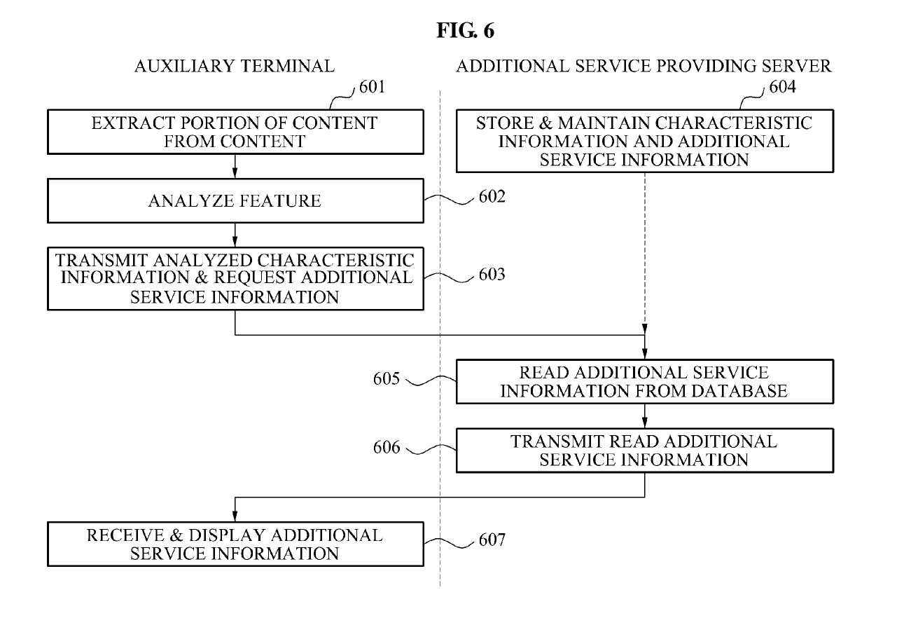

FIG. 6 illustrates a flowchart of a method of providing additional service information according to an example embodiment of the present invention.

In operation 601, a portion of a content output from an external device (namely, a main playback device) may be extracted from the content by an auxiliary terminal.

In the example embodiment of the present invention, the content may be described as an image content or a sound content, however there is no limitation thereto. Accordingly, the content may be of various types.

In an example in which an image content is output, a capture image may be acquired by the auxiliary terminal capturing the image content, to extract a portion of the image content.

In another example in which a sound content is output, a recording file may be acquired by the auxiliary terminal recording the sound content, to extract a portion of the sound content.

The main playback device may output an image or a sound, and may be interpreted as an output device for outputting a broadcast or a stored moving image through a sound output device, or through a playback device, such as a Cathode-Ray Tube (CRT), a Liquid Crystal Display (LCD), a Plasma Display Panel (PDP), a Light Emitting Diode (LED), and the like. The main playback device may include, for example, a Personal Computer (PC), or a Television (TV).

Additionally, content to be captured or recorded may be interpreted as various types of content or advertisement, through terrestrial digital/analog broadcasting, satellite broadcasting, an Internet Protocol Television (IPTV), a Cable Television (CATV), a Digital Cable Television (DCATV), Video on Demand (VoD), streaming, playback of stored content, and the like.

An image content may include, for example, a single image, a plurality of images captured at appropriate intervals, or a moving image acquired through continuous capturing for a predetermined period of time. A sound content may include, for example, a single sample, or a plurality of samples.

In operation 602, at least one piece of feature may be analyzed from the extracted portion of the content by the auxiliary terminal.

In operation 603, a request for additional service information may be transmitted by the auxiliary terminal to a selected server, namely an additional service information providing server, based on the analyzed feature.

Here, the additional service information providing server may maintain a database, to provide the additional service information in response to the request of the auxiliary terminal.

In operation 604, the feature and the additional service information may be associated with each other, and the associated information may be stored and maintained in the database, by the additional service information providing server.

In operation 605, the feature may be received, and additional service information corresponding to the received feature may be read from the database, based on the received feature, by the additional service information providing server.

In operation 606, the read additional service information may be transmitted to the auxiliary terminal by the additional service information providing server.

In operation 607, the additional service information may be received by the auxiliary terminal from the additional service information providing server, and the received additional service information may be displayed on a screen by the auxiliary terminal.

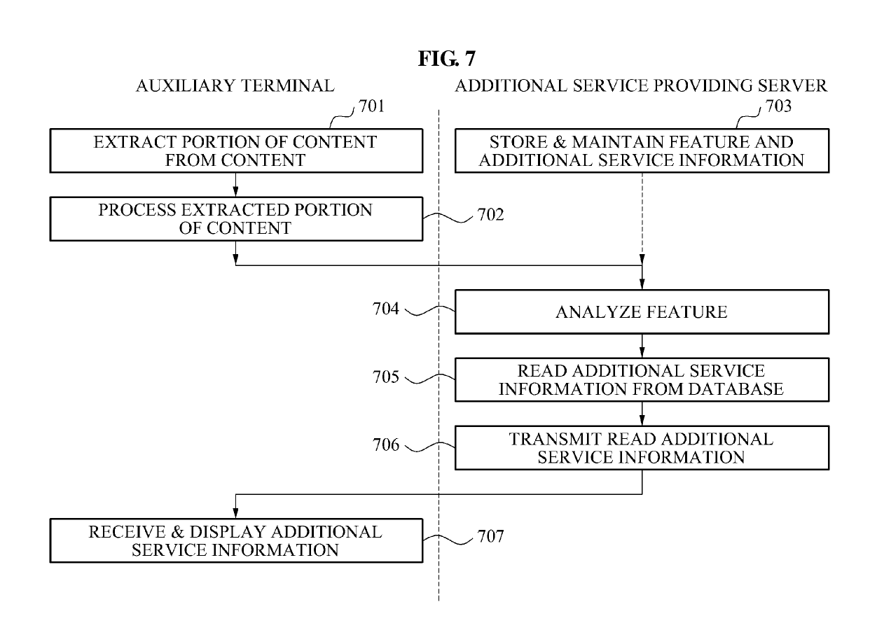

FIG. 7 illustrates a flowchart of a method of providing additional service information according to another example embodiment of the present invention.

In FIG. 7, an auxiliary terminal may only extract a portion of a content output from a main playback device, and an additional service information providing server may analyze feature from the extracted portion of the content, and may read additional service information.

Specifically, in operation 701, a portion of a content output from an external device (namely, a main playback device) may be extracted from the content by the auxiliary terminal.

In operation 702, the extracted portion of the content may be processed in a format suitable for being transmitted.

To process acquired image data or acquired sound data in a format suitable for being transmitted to a server, resizing, and extracting of ROI may be performed on the image data, and compressing, and encrypting for security may be performed on the image data and sound data.

Here, the additional service information providing server may maintain a database.

In operation 703, feature and the additional service information may be associated with each other, and the associated information may be stored and maintained in the database, by the additional service information providing server.

In operation 704, the feature may be analyzed from the extracted portion of the content by the additional service information providing server.

In other words, the feature may be analyzed through the additional service information providing server, instead of the auxiliary terminal directly analyzing the feature from the portion of the content.

In operation 705, the additional service information may be read from the database based on the analyzed feature by the additional service information providing server.

In operation 706, the read additional service information may be transmitted to the auxiliary terminal by the additional service information providing server.

In operation 707, the additional service information may be received by the auxiliary terminal, and the received the received additional service information may be displayed on a screen by the auxiliary terminal.

As a result, using the method of providing additional service information, it is possible to acquire additional service information associated with a viewing content, without limiting a playback and viewing of a digital content.

Accordingly, an auxiliary terminal may also be interpreted as a user terminal for example a cellular phone, a Personal Digital Assistant (PDA), a Portable Multimedia Player (PMP), and the like.

To acquire additional service information associated with a content using an auxiliary terminal, an interface between the auxiliary terminal and a device for playing back content may be ensured first. Additionally, costs for realizing the interface may be minimized to smoothly spread the auxiliary terminal on a market, and a compatibility between the auxiliary terminal and conventional content playback devices may be ensured.

The operating method of the auxiliary terminal and the method of providing additional service information according to the above-described example embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments of the present invention, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described to example embodiments of the present invention, or vice versa.

Although example embodiments of the present invention have been shown and described, it would be appreciated by those skilled in the art that changes may be made in these example embodiments of the present invention without departing from the principles and spirit of the disclosure, the scope of which is defined in the claims and their equivalents.

What is claimed is:

1. An auxiliary terminal, comprising:
a content extractor to extract a portion of a content from the content, the content being output from an external device;
a feature analyzer to analyze at least one piece of feature from the extracted portion of the content; and
an additional service information receiver to receive, from a selected server, additional service information corresponding to the content, based on the analyzed feature, to the selected server associating the feature with the additional service information and storing the feature and the additional service information.

2. The auxiliary terminal of claim 1, wherein an image content is output from the external device, and
wherein the content extractor acquires a capture image by capturing the image content, to extract a portion of the image content.

3. The auxiliary terminal of claim 2, wherein the feature comprises at least one of luminance information and color information that are contained in the capture image.

4. The auxiliary terminal of claim 2, wherein the feature is a water mark inserted into the image content.

5. The auxiliary terminal of claim 1, wherein a sound content is output from the external device, and
wherein the content extractor acquires a recording file by recording the sound content, to extract a portion of the sound content.

6. The auxiliary terminal of claim 5, wherein the feature comprises frequency information for each period contained in the recording file.

7. The auxiliary terminal of claim 1, wherein the additional service information receiver transmits the analyzed feature to the selected server, and receives, from the selected server, the additional service information corresponding to the analyzed feature.

8. An auxiliary terminal, comprising:
a content extractor to extract a portion of a content from the content, the content being output from an external device;
a content processor to process the extracted portion of the content in a selected format; and
an additional service information receiver to transmit the processed portion of the content to a selected server, and to receive, from the selected server, additional service information corresponding to the processed portion of the content,
wherein the selected server associates feature with the additional service information, stores the feature and the additional service information, analyzes the feature from the processed portion of the content, extracts the additional service information corresponding to the analyzed feature, and transmits the extracted additional service information to the additional service information receiver.

9. The auxiliary terminal of claim 8, wherein the content processor performs at least one of resizing, extracting of a Region Of Interest (ROI), compressing, and encrypting, and processes the extracted portion of the content.

10. An additional service information providing system, comprising:
an additional service information providing server to store and maintain at least one piece of feature and additional service information corresponding to the feature; and
an auxiliary terminal to analyze feature from a portion of a content output from an external device, and to receive additional service information corresponding to the content from the additional service information providing server based on the analyzed feature.

11. The additional service information providing system of claim 10, wherein the additional service information comprises at least one of content description information, advertisement information, and Electronic Program Guide (EPG) information.

12. The additional service information providing system of claim 10, wherein the auxiliary terminal is a mobile communication terminal comprising at least one of a camera module and a microphone module.

13. An additional service information providing system, comprising:
an additional service information providing server to store and maintain at least one piece of feature, and additional service information corresponding to the feature; and
an auxiliary terminal to receive additional service information corresponding to a content from the additional service information providing server based on a portion of the content, the content being output from an external device,
wherein the additional service information providing server analyzes the feature from the portion of the content, extracts the additional service information corresponding to the analyzed feature, and provides the auxiliary terminal with the extracted additional service information.

14. The additional service information providing system of claim 13, wherein the auxiliary terminal performs at least one of resizing, extracting of a Region Of Interest (ROI), compressing, and encrypting, with respect to the portion of the content, and transmits the processed portion of the content to the additional service information providing server.

15. An operating method of an auxiliary terminal, the operating method comprising:
extracting a portion of a content from the content, the content being output from an to external device;
analyzing at least one piece of feature from the extracted portion of the content; and
receiving, from a selected server, additional service information corresponding to the content, based on the analyzed feature, the selected server associating the feature with the additional service information and storing the feature and the additional service information.

16. The operating method of claim 15, wherein an image content is output from the external device, and
wherein the extracting comprises acquiring a capture image by capturing the image content.

17. The operating method of claim 15, wherein a sound content is output from the external device, and
wherein the extracting comprises acquiring a recording file by recording the sound content.

18. A method of providing additional service information, the method comprising:
storing and maintaining, in an additional service information providing server, at least one piece of feature, and additional service information corresponding to the feature; and
analyzing feature from a portion of a content output from an external device, and receiving additional service information corresponding to the content from the additional service information providing server based on the analyzed feature.

19. The method of claim 18, further comprising:
outputting the received additional service information using at least one of a speaker module and a display module.
